(19) United States
(12) Patent Application Publication
(10) Pub. No.: US 2019/0313602 A1
(43) Pub. Date: Oct. 17, 2019

(54) HAY BAG

(71) Applicant: Kelley and Company, LLC, Yellow Springs, OH (US)

(72) Inventor: Nancy D. Kelley, Yellow Springs, OH (US)

(21) Appl. No.: 16/259,299

(22) Filed: Jan. 28, 2019

Related U.S. Application Data
(60) Provisional application No. 62/655,908, filed on Apr. 11, 2018.

(51) Int. Cl. A01K 5/00; A01F 25/14; B32B 5/02

(52) U.S. Cl. CPC A01K 5/008; B32B 2439/46; B32B 5/024; A01F 25/14

(57) ABSTRACT

A hay bag comprises a shell and a hanger coupled to the shell. The shell includes a generally square-shaped first panel with a corner and an access hole. Further, the shell includes a generally square-shaped second panel with a corner that corresponds to the corner of the first panel. The first panel couples to the second panel at the corner and the corresponding corner and creates an opening along an edge of the shell between the first panel and the second panel. The hanger couples to the corner of the first panel and the corner of the second panel of the shell, such that the hanger does not couple anywhere else on the shell. Therefore, when hung, the hay bag hangs at an approximate forty-five-degree angle relative to the generally square shape of the first panel.

### CROSS REFERENCE TO RELATED APPLICATIONS

This application claims the benefit of U.S. Provisional Patent Application Ser. No. 62/655,908, filed Apr. 11, 2018, entitled “HAY BAG”, the disclosure of which is hereby incorporated by reference.

### BACKGROUND

Various aspects of the present invention relate generally to bags for feeding horses and other animals and specifically to hay bags that may be hung from a wall.

Hay bags are bags that hold fodder (usually dried hay) for animals to eat. In some cases, hay bags include a hanger that allows the hay bag to be hung from a hook or peg on a wall (e.g., in a trailer, a barn, a stall, etc.). Once the animal eats the fodder within the hay bag, the hay bag must be refilled for the animal to access to more fodder.

### BRIEF SUMMARY

According to aspects of the present invention, a hay bag comprises a shell and a hanger coupled to the shell. The shell includes a generally square-shaped first panel with a corner and an access hole. Further, the shell includes a generally square-shaped second panel with a corner that corresponds to the corner of the first panel. The first panel couples to the second panel at the corner and the corresponding corner and creates an opening along an edge of the shell between the first panel and the second panel. The hanger couples to the corner of the first panel and the corner of the second panel of the shell, such that the hanger does not couple anywhere else on the shell. Therefore, when hung, the hay bag hangs at an approximate forty-five-degree angle relative to the generally square shape of the first panel.

### BRIEF DESCRIPTION OF THE SEVERAL VIEWS OF THE DRAWINGS

FIG. 1 is an illustration of a hay bag that hangs at an approximately forty-five-degree angle, according to aspects of the present disclosure;

FIG. 2 is an illustration of the hay bag of FIG. 1 with an open flap, according to aspects of the present disclosure; and

FIG. 3 illustrates another embodiment of a hay bag that hangs at an approximately forty-five-degree angle, according to various aspects of the present disclosure.

### DETAILED DESCRIPTION

According to various aspects of the present disclosure, a hay bag includes a hanger that is coupled only to a corner of the hay bag such that when the hay bag is hung from the hanger, the hay bag is at an approximately forty-five-degree angle. An opening in the hay bag is therefore presented at an angle, so when a user wants to add fodder to the hay bag, the user does not need to remove the hay bag from the hanger.

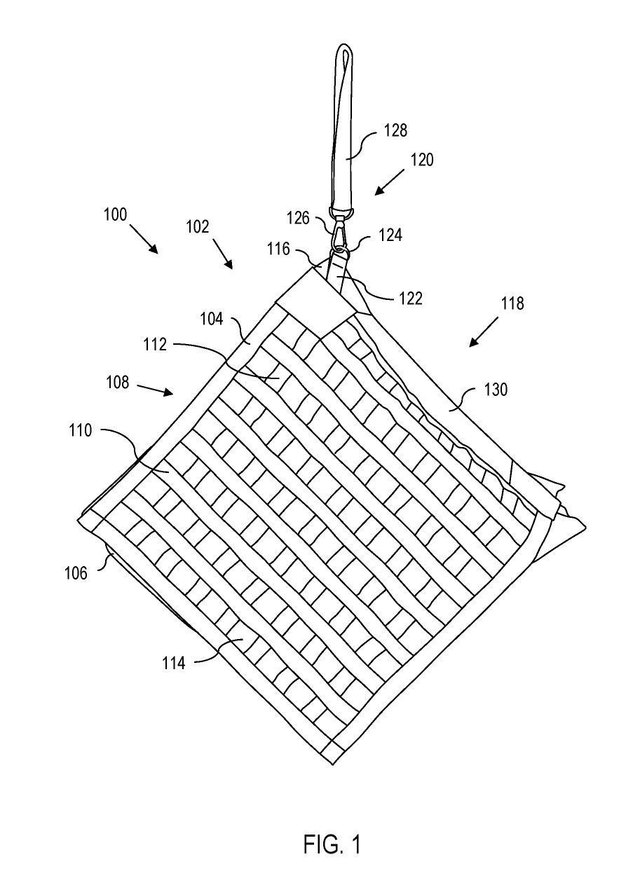

Turning now to FIG. 1, a hay bag 100 is shown in a hanging position. The hay bag includes a shell 102 comprising a first (front) panel 104 and a second (rear) panel 106, which are generally square shaped. The rear panel 106 is generally the same shape as the front panel 104 and couples to the front panel 104.

The front panel includes an access hole. In the embodiment of FIG. 1, the access hole is a grid 108 comprising a set of generally parallel fabric strips 110 in a first direction and a set of generally parallel fabric strips 112 in a second direction, approximately orthogonal to the first direction. Thus, there are spaces 114 between the two sets of fabric strips 110, 112. Therefore, when the hay bag 100 is filled with fodder (e.g., hay), an animal has access to the fodder via the spaces 114 between the two sets of fabric strips 110, 112. Thus, the spaces 114 between the two sets of fabric strips 110, 112 are the access hole.

While shown as generally square shaped in FIG. 1, the front panel 104 may be any desired shape that includes a corner 116. Further, the rear panel 106 has a shape that corresponds to the shape of the front panel 104. Thus, the rear panel 104 also includes a corresponding corner (not shown). The corner 116 of the front panel 104 couples to the corresponding corner of the rear panel 106. In some embodiments, the corners are coupled directly together, and in other embodiments, the corners are coupled together through a panel to give the hay bag 100 more depth (i.e., more space to hold fodder). The corners discussed herein are not required to have a sharp right angle. For example, the corner 116 may be rounded, have an acute angle, have an obtuse angle, or combinations thereof.

While the front panel 104 includes the grid 108 described above, the rear panel 106 may be a solid panel, because when the hay bag 100 is hung, the rear panel 106 most likely faces a wall of a structure. However, in some embodiments, the rear panel 106 also include a grid and spaces similar to the grid 108 and spaces 114 of the front panel 104.

Moreover, the hay bag 100 includes an opening 118 between the front panel 104 and the rear panel 106. Thus, a user can fill the hay bag 100 with fodder through the opening 118.

Further, the hay bag 100 includes a hanger 120 coupled to the corner 116 of the front panel 104 but does not couple to anywhere else on the front panel 104. While the hanger 120 does not couple to anywhere else on the front panel 104, in some embodiments, the hanger 120 also couples to the corresponding corner of the rear panel 106. However, if the hanger 120 does couple to the corresponding corner of the rear panel 106, the hanger 120 does not couple to anywhere else on the rear panel 104. Thus, when the hay bag 100 is hung, the hay bag 100 hangs at an approximate forty-five-degree angle, as shown in FIG. 1. This forty-five-degree angle allows the opening 118 to remain open, even when gravity pulls down on the hay bag 100. In conventional hay bags that have the hanger couple to two places on a panel or to two corners that do not correspond, the weight of the conventional hay bag closes the opening and the hanger may get in the way of the opening when the user is trying to fill the conventional hay bag. Thus, a user must remove the conventional hay bag from the hanging position when filling the conventional hay bag with fodder. On the other hand, the hay bag 100 described herein allow the user access to the opening 118 without the hanger 120 obstructing the access. Further, the hay bag 100 does not shut due to weight. Therefore, when a user wants to add fodder to the hay bag 100, the user does not need to remove the hay bag 100 from the hanging position.

The hanger 120 may couple to the corner 116 of the front panel 104 and the corresponding corner of the rear panel 106 in any fashion. For example, the hanger 120 may couple to the corner 116 of the front panel 104 on an outside location, as shown in FIG. 1. However, the hanger 120 may instead be coupled between the corner 116 and the corresponding corner.

As shown in FIG. 1, the hanger 120 includes a lead 122 and a ring 124 coupled to an end of the lead 122. In such a configuration, the hanger may also include a hook 126 and a strap 128 that loops from the hook 126 back to the hook 126. Thus, the user may hang the hay bag 100 from a hook, peg, etc. on a wall via the looped strap 128.

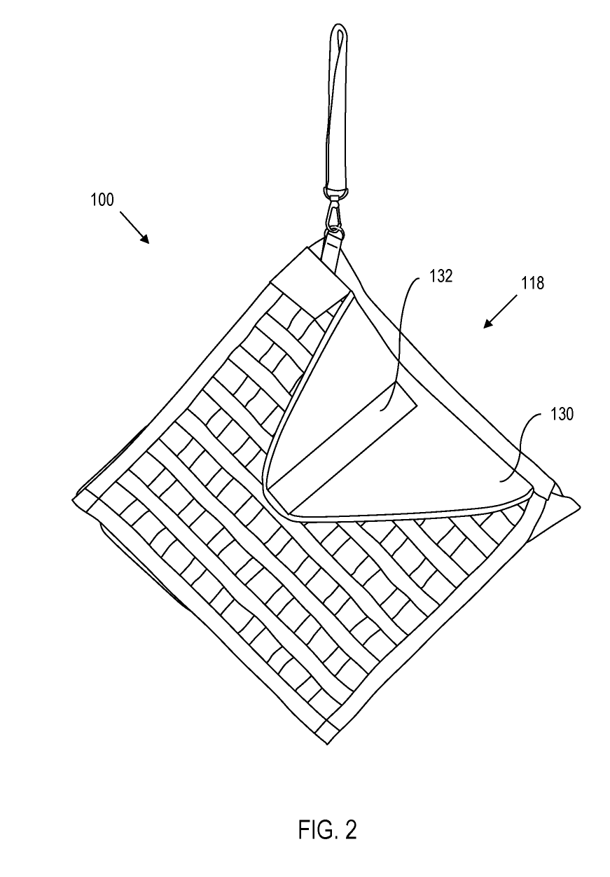

As discussed above, the hay bag 100 does not automatically close due to weight of the hay bag 100 when hung. However, in some cases, it is desirable to close the opening 118 of the hay bag 100 (e.g., when an animal is feeding from the hay bag). As such, embodiments of the hay bag 100 include a flap 130 coupled to the front panel 104 that spans the opening 118 when the flap 130 is coupled to the rear panel 106 (e.g., via a hook and loop fastener 132, FIG. 2) as shown in FIG. 1. FIG. 2 illustrates the hay bag 100 with the flap 130 in an open position; thus, the opening 118 is exposed. FIG. 1 illustrates the hay bag 100 with the flap 130 in a closed position; thus, the opening 118 is covered.

Further, the opening 118 of the hay bag 100 may include a fastener (e.g., a hook and loop fastener) that couples the front panel 104 of the shell 102 to the rear panel 106 of the shell 102 around the opening 118.

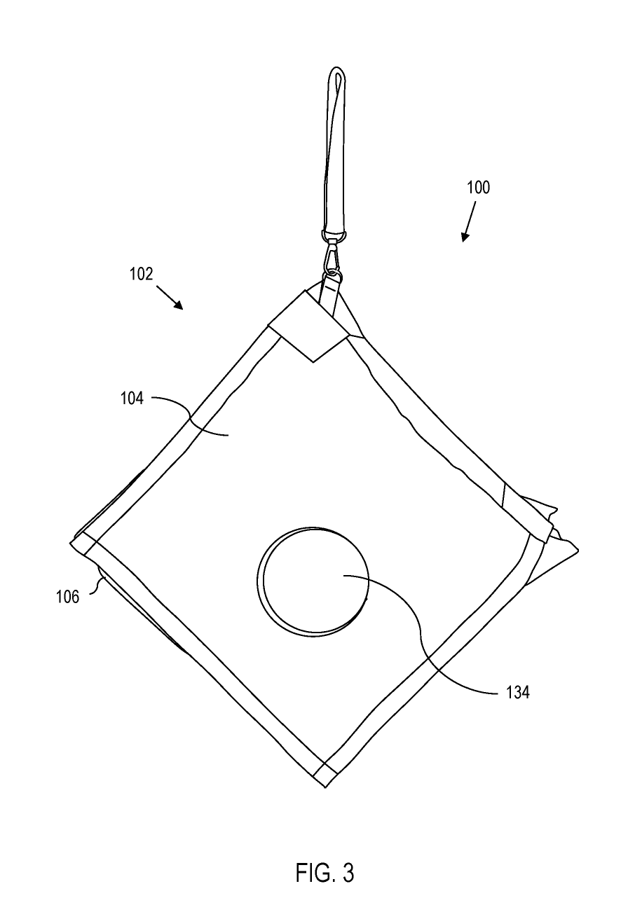

Turning to FIG. 3, another embodiment of the hay bag 100 is shown. The hay bag 100 includes a shell 102 comprising a first (front) panel 104 and a second (rear) panel 106, which are generally square shaped. The rear panel 106 is generally the same shape as the front panel 104 and couples to the front panel 104.

The front panel includes an access hole. In the embodiment of FIG. 3, the access hole is a hole 134 in the first panel 104, which is a solid panel otherwise. Therefore, when the hay bag 100 is filled with fodder (e.g., hay), an animal has access to the fodder via the hole 134. The other components of the embodiment of the hay bag 100 of FIG. 3 are similar to the components described above in reference to FIGS. 1-2.

As mentioned above, in the embodiments of the hay bag 100 described herein, the hanger 120 couples to the shell 102 at one point (i.e., the corner 116 of the front panel 104) or two corresponding points (i.e., the corner 116 of the front panel 104 and the corresponding point on the rear panel 106). Thus, when the hay bag 100 is in a hanging position, the hay bag 100 rests at an approximately forty-five-degree angle, which allows the opening 118 to remain open, even when gravity pulls down on the hay bag 100. Therefore, when a user wants to add fodder to the hay bag 100, the user does not need to remove the hay bag 100 from the hanging position. This is an advantage over conventional hay bags (e.g., hay bags that have a hanger coupled to two separate, non-corresponding points), because when in the hanging position, the opening remains open and the hanger is not in the way. On the other hand, conventional hay bags may have the opening closed due to weight of the conventional hay bag, the hanger may get in the way of filling the hay bag, or both.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. Aspects of the disclosure were chosen and described in order to best explain the principles of the invention and the practical application, and to enable others of ordinary skill in the art to understand the invention for various embodiments with various modifications as are suited to the particular use contemplated.

What is claimed is:

1. A hay bag comprising:
a shell comprising:
a first panel comprising:
a shape including a corner; and
an access hole allowing access to an interior of the hay bag;
a second panel comprising:
a shape with a corner, wherein the shape of the second panel corresponds to the shape of the first panel and is solid, wherein the corner of the second panel is coupled to the corner of the first panel; and
an opening between the first panel and the second panel;
a hanger coupled to the corner of the first panel of the shell, wherein the hanger does not couple anywhere else on the first panel.

2. The hay bag of claim 1, wherein the hanger further couples to the corner of the second panel but does not couple anywhere else on the second panel.

3. The hay bag of claim 2, wherein the hanger only couples to the shell at the corner of the first panel and the corner of the second panel such that when hung, the hay bag hangs at an approximate forty-five-degree angle.

4. The hay bag of claim 3, wherein the hanger couples to the shell between the corner of the first panel and the corner of the second panel.

5. The hay bag of claim 1, wherein the hanger comprises:
a lead; and
a ring coupled to an end of the lead.

6. The hay bag of claim 5, wherein the hanger further comprises:
a hook that couples to the ring; and
a strap that loops from the hook back to the hook.

7. The hay bag of claim 1, wherein the shape of the first panel is generally square-shaped.

8. The hay bag of claim 1, wherein the first panel includes a grid, and the access hole includes the spaces between the grid.

9. The hay bag of claim 1, wherein the first panel is a solid panel, and the access hole is a hole in the solid panel.

10. The hay bag of claim 1, wherein the second panel is a solid panel.

11. The hay bag of claim 10, wherein the second panel includes an opening in the solid panel.

12. The hay bag of claim 1, wherein the second panel comprises:
a grid; and
spaces within the grid.

13. The hay bag of claim 1 further comprising a flap that covers the opening in the shell when closed.

14. The hay bag of claim 1 further comprising a fastener that selectively fastens the opening in the shell.

15. A hay bag comprising:
a shell comprising:
a first panel comprising:
a generally square shape including a corner;
a grid; and
spaces within the grid;
a second panel comprising:
a solid shape with a corner, wherein the shape of the second panel corresponds to the shape of the first panel, wherein the corner of the second panel is coupled to the corner of the first panel and the corner of the second panel;
an opening between the first panel and the second panel;
a fastener that selectively fastens the opening in the shell;
a flap that covers the opening in the shell when the flap is closed;
a hanger coupled to the corner of the first panel and the corner of the second panel of the shell, wherein the hanger does not couple anywhere else on the shell such that when hung, the hay bag hangs at an approximate forty-five-degree angle relative to the generally square shape of the first panel.
